(19) United States
(12) Patent Application Publication
(10) Pub. No.: US 2018/0017273 A1
(43) Pub. Date: Jan. 18, 2018

(54) SMART VENTILATION FAN SYSTEM AND SMART VENTILATION FAN DEVICE

(71) Applicant: Delta Electronics, Inc., Taoyuan City (TW)

(72) Inventors: Yueh-Shan LIN, Taoyuan City (TW); Yen-Lin CHEN, Taoyuan City (TW); Tsung-Wei CHEN, Taoyuan City (TW)

(21) Appl. No.: 15/296,240

(22) Filed: Oct. 18, 2016

(30) Foreign Application Priority Data
Jul. 15, 2016 (TW) 105122353

(51) Int. Cl. F24F 7/007; G05B 19/048; F24F 11/00

(52) U.S. Cl. CPC F24F 7/007; F24F 11/0012; F24F 11/0015; G05B 19/048; F24F 11/0001; F24F 11/0086; F24F 2011/0091; G05B 2219/2614; F24F 2011/0057

(57) ABSTRACT

A smart ventilation fan device includes a fan, a light-emitting module, a sensor set, a wireless module and a control circuit. The fan includes a motor. The sensor set is for sensing environment information. The wireless module is for receiving a command signal from an electronic device and for transmitting the environment information and ventilation fan device information to the electronic device. The control circuit includes a micro-controller which is for generating a control signal according to the command signal received from the wireless module, so as to control the motor of the fan to rotate, and the micro-controller processes the environment information sensed by the sensor set and/or the ventilation fan information. The micro-controller of the control circuit transmits the environment information and/or the ventilation fan information to the electronic device through the wireless module. The invention further includes a smart ventilation fan system.

### CROSS REFERENCE TO RELATED APPLICATIONS

This Application claims priority of Taiwan Patent Application No. 105122353, filed on Jul. 15, 2016, the entirety of which is incorporated by reference herein.

### BACKGROUND OF THE INVENTION

### Field of the Invention

The present invention is related to a ventilation fan device and ventilation fan system, and in particular to a ventilation fan device and ventilation fan system controlled by a wireless method.

### Description of the Related Art

Conventional ventilation fan devices have the functions of startup and shutdown, or they have a multi-level air-volume adjustment function. In addition, some conventional ventilation fan devices have an illumination function. For example, a light-emitting diode can be set on the covering body of a ventilation fan device.

If a user wants to adjust some of the settings of the ventilation fan device, such as the setting for air volume, the user has to adjust a knob or a switch on the ventilation fan device. However, conventional ventilation fan devices have to be installed over a specific height, such as 2.3 meters, making it inconvenient for the user to adjust settings on the ventilation fan device. Therefore, solving the problems of conventional ventilation fan devices is an important issue.

### BRIEF SUMMARY OF THE INVENTION

For the reasons listed above, the present invention provides a ventilation fan device to solve problems of the conventional ventilation fan device.

The invention discloses a smart ventilation fan device, including a fan, a light-emitting module, a sensor set, a wireless module and a control circuit. The fan includes a motor. The sensor set is for sensing environment information outside of the smart ventilation fan device. The wireless module is for receiving a command signal from an electronic device and for transmitting the environment information and/or ventilation fan device information to the electronic device. The control circuit is electrically connected to the fan, the light-emitting module, the sensor set and the wireless module. The control circuit includes a micro-controller which is for generating a control signal according to the command signal received from the wireless module, so as to control the motor of the fan to rotate, and the micro-controller processes the environment information sensed by the sensor set and/or the ventilation fan device information. The micro-controller of the control circuit transmits the environment information and/or the ventilation fan device information to the electronic device through the wireless module. The invention further discloses a smart ventilation fan system.

According to the disclosure, the invention discloses a smart ventilation fan system including an electronic device and a smart ventilation fan device. The electronic device includes a human interface, a processor, a first wireless module and a storage medium. The human interface is for receiving an input signal. The processor is for generating a command signal according to the input signal. The first wireless module is for outputting the command signal. The storage medium includes an application program which is processed by the processor. The smart ventilation fan device includes a fan, a sensor set, a second wireless module and a control circuit. The fan includes a motor. The sensor set is for sensing environment information outside of the smart ventilation fan device. The second wireless module communicates with the first wireless module for receiving the command signal from the electronic device and transmitting the environment information and/or ventilation fan device information to the electronic device. The control circuit is for electrically connecting to the fan, the sensor set and the second wireless module. The control circuit includes a micro-controller, and the micro-controller generates a control signal according to the command signal received by the second wireless module, so as to control the motor of the fan to rotate. The micro-controller processes the environment information sensed by the sensor set and/or the ventilation fan device information and transmitting the environment information and/or the ventilation fan device information to the electronic device through the second wireless module. The processor runs the application program to show the environment information and/or the ventilation fan device information on the human interface of the electronic device

In contrast to the prior art, the smart ventilation fan system of the invention discloses a smart ventilation fan device combined with the user's smart electronic device (such as a mobile phone or a tablet) via wireless communication technology. When the smart electronic device detects the wireless module in the smart ventilation fan device, the smart electronic device can be paired to the wireless module. After the pairing procedure, the smart electronic device is combined with the smart electronic device, so that the user can use the smart electronic device to monitor current states (such as fan speed, ventilation volume, temperature and humidity of the environment) of the smart ventilation fan device. The user also can use the smart electronic device to adjust the settings of the functions of the smart ventilation fan device and to adjust the brightness, color temperature and several modes of the light-emitting module in a wireless manner. The invention can reduce the cost of external accessories and of the construction procedure. Conventionally, the ventilation volume and settings of a conventional high-level ventilation fan device needs to be set up completely when installing the conventional high-level ventilation fan device. After installation, when the user wants to adjust some functions, the user has to remove the cover of the conventional high-level ventilation fan device to adjust the conventional high-level ventilation fan device. Thus, it is inconvenient and unsafe for the user to set up the functions of the conventional high-level ventilation fan device. However, the present invention, it is easy and convenient for the user to use the smart electronic device to remotely control or adjust the settings of the smart ventilation fan device.

### BRIEF DESCRIPTION OF THE DRAWINGS

The present invention can be more fully understood by reading the subsequent detailed description and examples with references made to the accompanying drawings, wherein:

FIG. 1 is a block diagram of a smart ventilation fan system according to an embodiment of the present invention.

FIG. 2 is a diagram of a smart ventilation fan device according to the embodiment of the present invention.

FIG. 3 is a diagram of a light-emitting module according to the embodiment of the present invention.

FIG. 4 is a diagram of a light-emitting module according to another embodiment of the present invention.

FIG.5 is a side view of the smart ventilation fan device according to the embodiment of the present invention.

FIG. 6 is a side view of the smart ventilation fan device according to another embodiment of the present invention.

FIG. 7 is a diagram of a human interface when an electronic device runs an application program according to the embodiment of the present invention.

FIG. 8 is a diagram of a setting screen according to the embodiment of the present invention.

FIG. 9 is a diagram of a humidity setting screen according to the embodiment of the present invention.

FIG. 10 is a diagram of a motion setting screen according to the embodiment of the present invention.

FIG. 11 is a diagram of a mode setting screen according to the embodiment of the present invention.

### DETAILED DESCRIPTION OF THE INVENTION

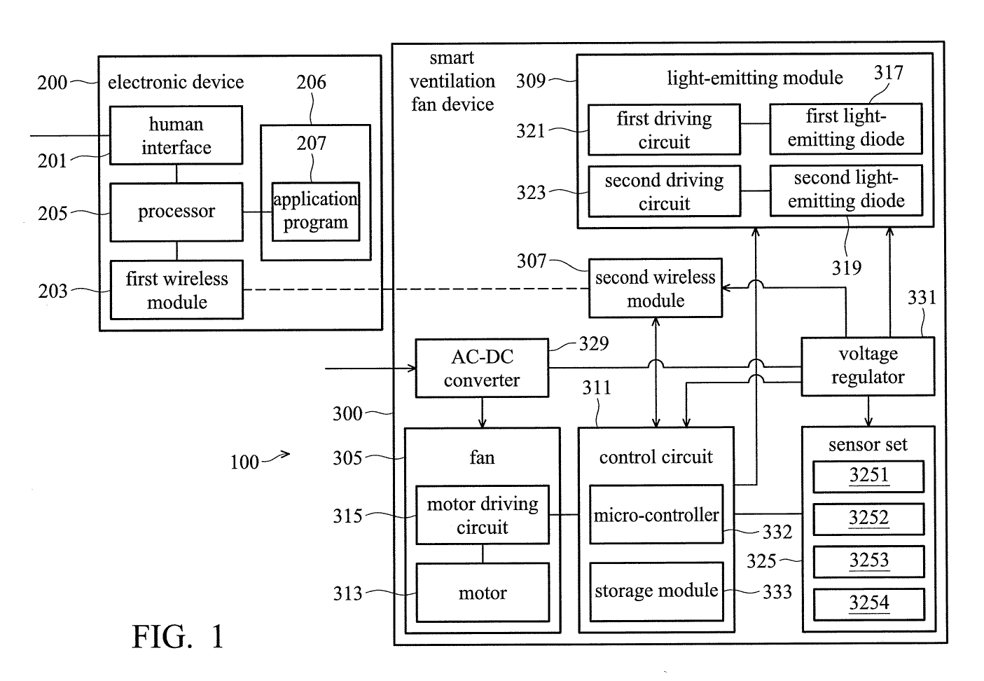

Please refer to FIG. 1, which is a block diagram of a smart ventilation fan system 100 according to an embodiment of the present invention. The smart ventilation fan system 100 includes an electronic device 200 and a smart ventilation fan device 300. The electronic device 200 can be a mobile device or a portable device, such as a personal digital assistant (PDA), a smartphone, a tablet, a mobile phone, a mobile Internet device (MID), a notebook computer, a car computer, digital media player, a gaming device or any other type of device, and including a combination of two or more of these mobile computing devices. However, it will be understood by a person skilled in the art that the present invention is not limited to those devices. The electronic device 200 includes a human interface 201, a first wireless module 203, a processor 205 and a storage medium 206 which stores an application program 207. The human interface 201 can include a LCD display or a touch panel for receiving an input signal from a user, and the human interface 201 transmits the input signal to the processor 205. Then, the processor 205 transforms the input signal to a command signal. The first wireless module 203 can be a Bluetooth module, a WIFI module or an Infrared wireless module, and the processor 205 can control the first wireless module 203 to output the command signal. The processor 205 runs the application program 207 to show information related to the application program 207 on the human interface 201. The electronic device 200 can run the application program 207 and can control the smart ventilation fan device 300 which is connected to the first wireless module 203 using the human interface 201 in the invention.

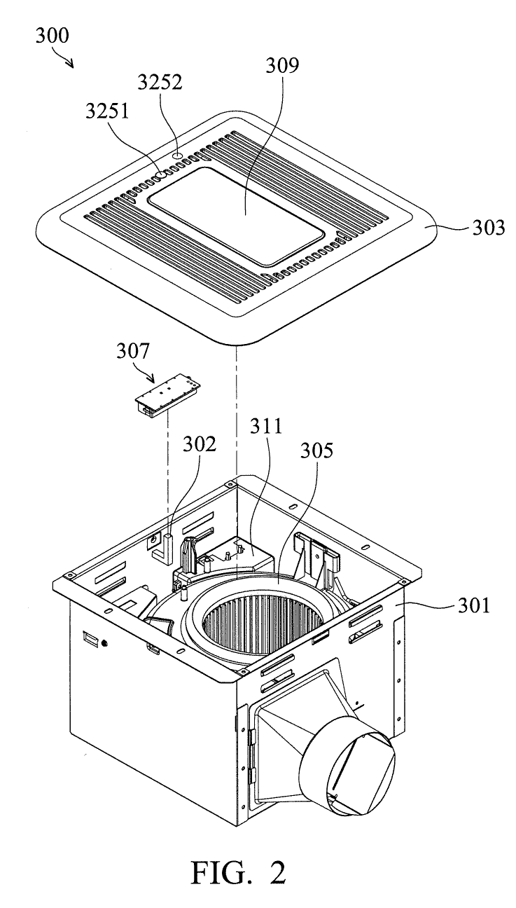

Please refer to FIG. 1 and FIG. 2 at the same time. FIG. 2 is a diagram of the smart ventilation fan device 300 according to the embodiment of the present invention. The smart ventilation fan device 300 can include a casing 301, a covering body 303, a fan 305, a second wireless module 307, a light-emitting module 309, a control circuit 311 and sensor set 325. For example, the sensor set 325 can include a motion sensor 3251, a gas sensor 3252 and/or a temperature sensor 3253, a humidity sensor 3254. The casing 301 can contain the fan 305, the second wireless module 307, the control circuit 311 and the temperature sensor 3253 and/or the humidity sensor 3254. The light-emitting module 309, the motion sensor 3251 and the gas sensor 3252 can be disposed on the covering body 303, and the covering body 303 can cover the casing 301, as shown in FIG. 2. In addition, the gas sensor 3252 can also be disposed in the casing 301 near an inlet of the fan 305 in another embodiment.

The fan 305 includes a motor 313 and a motor driving circuit 315. The motor driving circuit 315 is used for driving the motor 313 to rotate, so as to drive blades (not shown in the figures) of the fan 305 to rotate. In this embodiment, the motor 313 is a brushless DC motor, but it is not limited thereto.

The second wireless module 307 can be a Bluetooth module, a WIFI module or an Infrared wireless module, but it is not limited thereto. The second wireless module 307 is used for communicating with the first wireless module 203 to transmit data. For example, when the first wireless module 203 and the second wireless module 307 are two WIFI modules, they can use a WIFI Direct technology to communicate with each other and to transmit data to each other. For example, the second wireless module 307 can receive the command signal from the first wireless module 203. In addition, the smart ventilation fan device 300 can transmit environment information to the first wireless module 203 of the electronic device 200 through the second wireless module 307, and the processor 205 runs the application program 207 and controls the human interface 201 to show related information, such as wireless signal strength between the first wireless module 203 and the second wireless module 307. The wireless signal strength indicates the quality of the wireless connection between the electronic device 200 and the smart ventilation fan device 300.

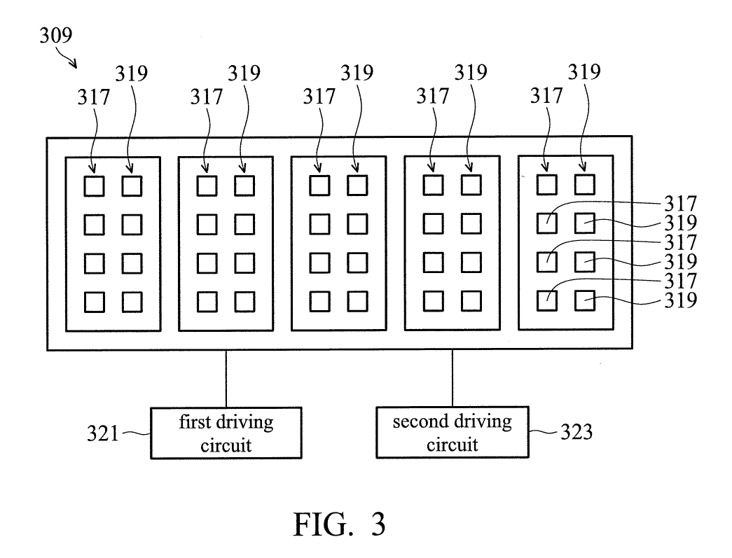

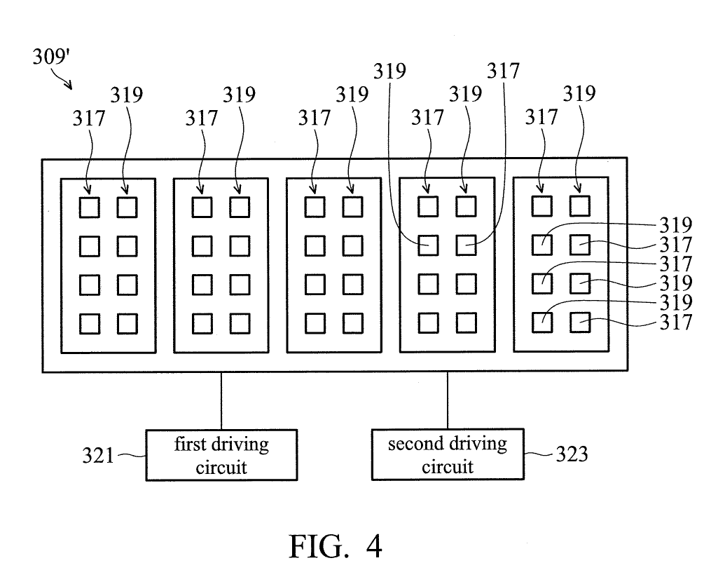

As shown in FIG. 2, the light-emitting module 309 is disposed on the covering body 303 for emitting light beams. Please refer to FIG. 3, which is a diagram of the light-emitting module 309 according to the embodiment of the present invention. In this embodiment, the light-emitting module 309 can include a plurality of first light-emitting diodes 317, a plurality of second light-emitting diodes 319, a first driving circuit 321 and a second driving circuit 323, but it is not limited thereto. The first driving circuit 321 and the second driving circuit 323 respectively drive the first light-emitting diodes 317 and the second light-emitting diodes 319 to emit the light beams. In this embodiment, the first light-emitting diodes 317 are for emitting the yellow light beams, and the second light-emitting diodes 319 are for emitting the white light beams. Furthermore, the first light-emitting diodes 317 and the second light-emitting diodes 319 can be arranged in a staggered manner. For example, as shown in FIG. 3, the first column on the right side includes four second light-emitting diodes 319, the second column includes four first light-emitting diodes 317, the third column includes four second light-emitting diodes 319, and so on. In addition, please refer to FIG. 4. FIG. 4 is a diagram of a light-emitting module 309′ according to another embodiment of the present invention. As shown in FIG. 4, the first light-emitting diodes 317 and the second light-emitting diodes 319 are arranged alternatively, wherein the light-emitting diodes near the first light-emitting diodes 317 (up, down, left, right) are the second light-emitting diodes 319, and the light-emitting diodes near the second light-emitting diodes 319 (up, down, left, right) are the first light-emitting diodes 317. For example, as shown in FIG. 4, the first column on the right side includes four light-emitting diodes which are arranged in sequence: a second light-emitting diodes 319, a first light-emitting diode 317, a second light-emitting diode 319 and a first light-emitting diode 317; the second column includes four light-emitting diodes which are arranged in sequence: a first light-emitting diode 317, a second light-emitting diode 319, a first light-emitting diode 317 and a second light-emitting diode 319; the third column includes four light-emitting diodes which are arranged in sequence: a second light-emitting diode 319, a first light-emitting diode 317, a second light-emitting diode 319 and a first light-emitting diode 317; and so on.

The sensor set 325 is electrically connected to the control circuit 311. The sensor set 325 is used for sensing environment information which includes motion information, gas concentration information (such as CO, CO2 or other toxic gases), temperature information and humidity information of an indoor environment in which the smart ventilation fan device 300 is located. As shown in FIG. 1, the sensor set 325 can include the motion sensor 3251, the gas sensor 3252 the temperature sensor 3253 and the humidity sensor 3254. The temperature sensor 3253 is used for sensing the temperature of the indoor environment in which the smart ventilation fan device 300 is located, the humidity sensor 3254 is used for sensing the humidity of the indoor environment in which the smart ventilation fan device 300 is located, the gas sensor 3252 is used for sensing the gas concentration (such CO1, CO2 and so on) of the indoor environment in which the smart ventilation fan device 300 is located, and the motion sensor 3251 is used for sensing motion of an object in the indoor environment. For example, the motion sensor 3251 can be a passive infrared sensor (PIR motion sensor) for sensing the motion of a human to determine whether there is a moving human or a moving object in the indoor environment. The environment information of the indoor environment in which the smart ventilation fan device 300 is located is sensed by the sensor set 325 and can be transmitted to the control circuit 311. The control circuit 311 can include a micro-controller (MCU) 332. The micro-controller 332 can be an integrated chip, and can include a central processor, memory, timer/counter, and an input and output interface integrated therein. The micro-controller 304 has the advantages of a simple input and output interface and a small size. The control circuit 311 is used for generating a control signal according to the command signal received by the second wireless module 307, so as to control the motor of the fan to rotate and/or to control the light-emitting module 309 to emit the light beams. The control signal for controlling the motor driving circuit 315 of the fan 305 can be a pulse width modulation signal (PWM signal). Furthermore, the control circuit 311 transmits the environment information and/or the ventilation fan device information (such as ventilation volume, power consumption and/or estimated electricity price and so on) to the electronic device 200 through the wireless module 307, and the processor 205 runs the application program 207 to show the environment information and/or the ventilation fan device information on the human interface 201 of the electronic device 200. Therefore, the user can use the electronic device 200 to instantly obtain the environment information outside of the smart ventilation fan device 300 and/or the ventilation fan device information, such as the temperature, the humidity, the gas concentration and/or ventilation volume, power consumption, estimated electricity price and so on.

As shown in FIG. 1, the smart ventilation fan device 300 can further include an AC-DC converter 329 and a voltage regulator 331. The AC-DC converter 329 receives and converts an external alternating current power into a direct current power, such as 24-volt DC power provided to the fan 305. The voltage regulator 331 converts the DC power into a control voltage for providing to the sensor set 325, the control circuit 311 and the second wireless module 307. For example, the voltage regulator 331 converts the 24-volt DC power into a control voltage with 5 volts for providing to the sensor set 325, and converts the 24-volt DC power into a control voltage with 3.3 volts for providing to the voltage regulator 331. In addition, the smart ventilation fan device 300 can further include a storage module 333, and the storage module 333 can be disposed on the control circuit 311 for storing a plurality of settings for the control circuit 311. These settings will be described later. In this embodiment, the storage module 333 can be implemented by an electrically-erasable programmable read-only memory (EEPROM), but it is not limited thereto.

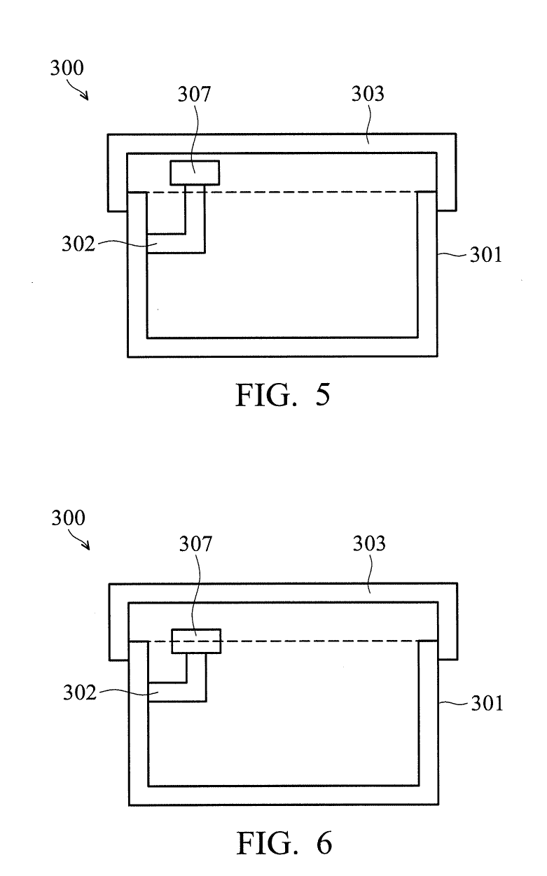

Please refer to FIG. 5 and FIG. 6. FIG. 5 is a side view of the smart ventilation fan device 300 according to the embodiment of the present invention. FIG. 6 is a side view of the smart ventilation fan device 300 according to another embodiment of the present invention. In the embodiment of FIG. 5, a base 302 is formed on an inner surface of the casing 301, and the second wireless module 307 is installed on the base 302. At this time, the second wireless module 307 is outside of the casing 301, so as to prevent the shielding effect from affecting the wireless signal strength of the second wireless module 307. In addition, as shown in FIG. 6, this design allows a part of the second wireless module 307 to be outside of the casing 301, so that the shielding effect can also be prevented. Moreover, in another embodiment, the second wireless module 307 can also be disposed on the covering body 303 directly.

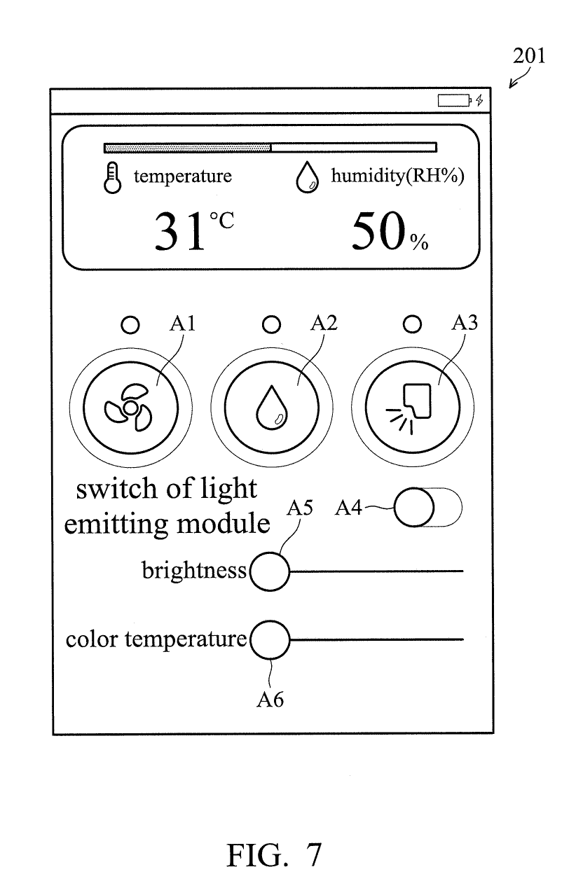

Please refer to FIG. 7, which is a diagram of the human interface 201 when the electronic device 200 runs the application program 207 according to the embodiment of the present invention. As shown in FIG. 7, the human interface 201 includes a touch display for displaying information related to the smart ventilation fan device 300. The touch display can show the temperature sensed by the temperature sensor 3253 and the humidity sensed by the humidity sensor 3254. In addition, the touch display of the human interface 201 includes several user options, such as four buttons A1, A2, A3 and A4 shown in the center of FIG. 7, and these four buttons are respectively used for determining whether the motor 313 of the fan 305, the humidity sensor 3254 and the motion sensor 3251 of the sensor set 325 and the light-emitting module 309 are enabled. For example, when the user touches the button A1, the human interface 201 receives the input signal, then the processor 205 generates the command signal according to the input signal, and the processor 205 controls the first wireless module 203 to transmit the command signal to the second wireless module 307. When the control circuit 311 receives the command signal through the second wireless module 307, the control circuit 311 generates a corresponding control signal to control the motor driving circuit 315 of the fan 305, so as to drive the motor 313 to rotate. When the user touches the button A1 again, the motor 313 of the fan 305 is controlled to stop rotating by the same procedure mention before. When the user touches the button A2 at the middle of the touch display, the function of the humidity sensor 3254 for sensing the humidity can be enabled or disabled. When the user touches the button A3 at the right side, the function of the motion sensor 3251 for sensing a moving object can be enabled or disabled. When the user touches the button A4, the light-emitting module 309 is controlled to emit the light beams, and when the user touches the button A4 again, the light-emitting module 309 is turned off.

Furthermore, as shown in FIG. 7, a bottom side of the human interface 201 shows two adjusting buttons A5 and A6 after the application program 207 is run. The adjusting button A5 is used for adjusting the brightness of the light beams emitted from the light-emitting module 309, and the brightness of the light beams can be divided into level 1 to level 100. When the user moves the adjusting button A5 to the left end, the brightness of the light beams emitted from the light-emitting module 309 is at a minimum (level 1). When the user moves the adjusting button A5 to the right end, the brightness of the light beams emitted from the light-emitting module 309 is at the maximum (level 100).

The adjusting button A6 is used for adjusting the color temperature of the light beams emitted from the light-emitting module 309, wherein the color temperature can be divided into level 0 to level 100. In this embodiment, the color temperature of the light beams emitted from the light-emitting module 309 ranges between 2300K and 5400K, but it is not limited thereto. When the user moves the adjusting button A6 to the left end, the color temperature of the light beams emitted from the light-emitting module 309 is 2300K (level 0, yellow light). When the user moves the adjusting button A5 to the right end, the color temperature of the light beams emitted from the light-emitting module 309 is 5400K (level 100, white light). A current percentage for driving the first light-emitting diodes 317 by the first driving circuit 321 and the current percentage for driving the second light-emitting diodes 319 by the second driving circuit 323 are derived from the following formulas:

X+Y=A;

BY=(100−B)X;

wherein X is a maximum current percentage for driving the first light-emitting diodes 317, Y is a maximum current percentage for driving the second light-emitting diodes 319, A corresponds to the brightness level adjusted by button A5 (i.e. level 1 to 100), and B corresponds to the level of the color temperature adjusted by button A6 (i.e. level 0 to 100). A and B are both integers. Therefore, X and Y can be derived from A and B specified by the user. For example, when the user specifies A is 100 and B is 50, the user can obtain that X is 50 and Y is 50. If the maximum current of the first driving circuit 321 is 1 A (1 ampere) and the maximum current of the second driving circuit 323 is 1 A, a driving current of the first driving circuit 321 for driving the first light-emitting diodes 317 is 0.5 A (1 A*50/100=0.5 A), and a driving current of the second driving circuit 323 for driving the second light-emitting diodes 319 is 0.5 A (1 A*50/100=0.5 A). In this design, the user can adjust the brightness and maintains the color temperature at the same time.

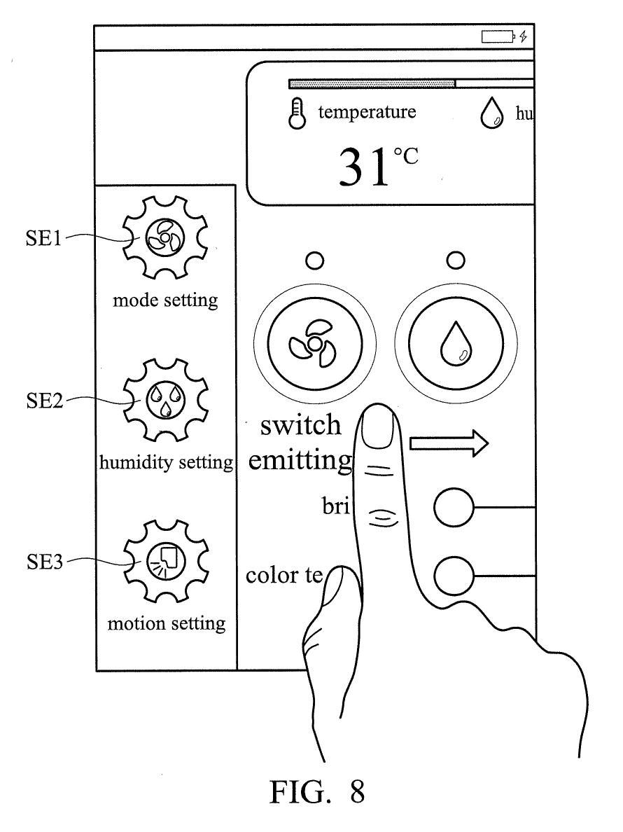

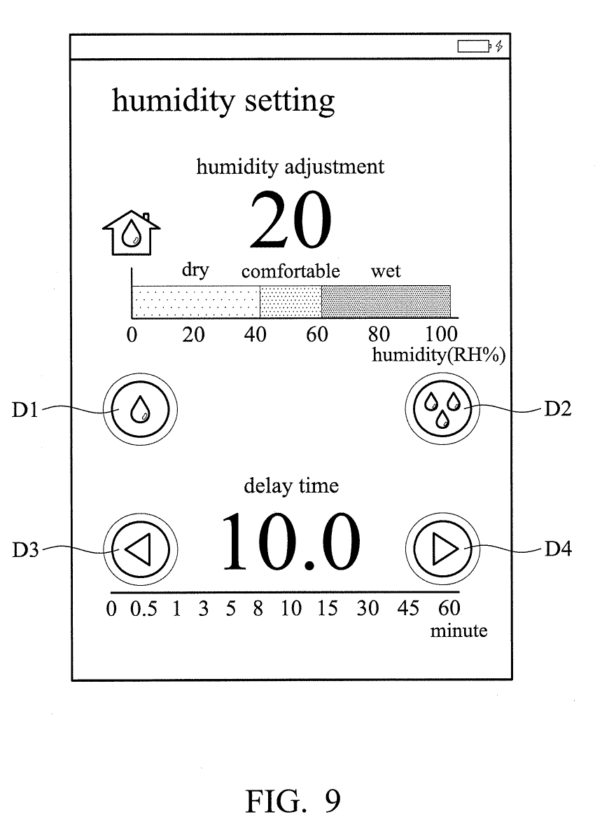

Please refer to FIG. 8 and FIG. 9. FIG. 8 is a diagram of a setting screen according to the embodiment of the present invention. When the user slides the touch display from the left side to the right side, the touch display shows the setting screen as shown in FIG. 8. The setting screen includes buttons SE1, SE2 and SE3. When the user touches the button SE2, the touch display switches to a humidity setting screen. FIG. 9 is a diagram of the humidity setting screen according to the embodiment of the present invention. The humidity setting screen shows a bar indicating the humidity (from 0 to 100). The user can touches a decrease button D1 and an increase button D2 to adjust a target humidity setting value. For example, if user needs a dry environment, the user can touch the decrease button D1 to specify the target humidity setting value as 20, so the electronic device 200 transmits the command signal to the smart ventilation fan device 300 through the first wireless module 203. The control circuit 311 specifies the target humidity setting value according to the command signal from the electronic device 200 and controls the motor 313 of the fan 305 to continuously rotate, so as to decrease the humidity of the indoor environment. Meanwhile, the control circuit 311 monitors whether a humidity value sensed by the humidity sensor 3254 achieves the target humidity setting value. In addition, the user can touch the decrease button D3 and an increase button D4 to adjust a delay time, such as specifying that the delay time is 10 minutes. When the humidity values sensed by the humidity sensor 3254 achieves the target humidity setting value (such as 20), the control circuit 311 controls the motor 311 of the fan 305 to continue to rotate in the delay time. That is, the motor 313 continues to rotate for 10 minutes. When over the delay time (such as 10 minutes), the control circuit 311 controls the motor 313 of the fan 305 to stop rotating. In addition, the smart ventilation fan device 300 provides a function for automatically enabling the fan 305 when the humidity value is high. The user can also set up the setting through the application program 207 that is run by the electronic device 200. The user can specify the target humidity setting value depending on the user's preference. Then, the humidity sensor 3254 senses the humidity of the indoor environment automatically. If the humidity value sensed by the humidity sensor 3254 is higher than the target humidity setting value, the control circuit 311 automatically controls the fan 305 of the smart ventilation fan device 300 to ventilate. The target humidity setting value is stored in the storage module 333.

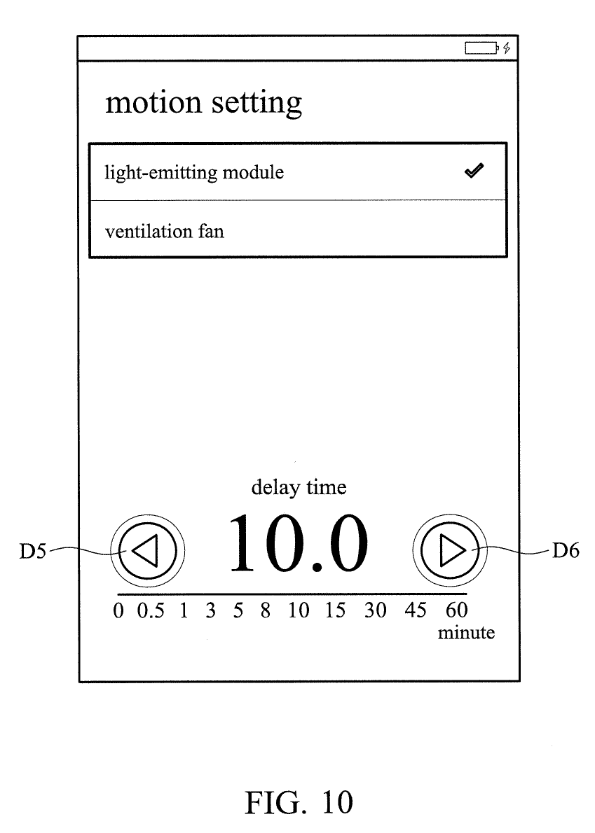

Please refer to FIG. 8 and FIG. 10. FIG. 10 is a diagram of a motion setting screen according to the embodiment of the present invention. The user can select a light-emitting module option and/or a fan option as shown in FIG. 10, so that when the motion sensor 3251 sensed the motion of an object, the control circuit 311 controls the motor 313 of the fan 305 to rotate and/or controls the light-emitting module 309 to be enabled. For example, the smart ventilation fan device 300 is installed in a bathroom, and the motor 313 of the fan 305 does not rotate before the user enters the bathroom. When the user enters the bathroom, the motion sensor 3251 senses the motion of the user, so that the control circuit 311 controls the motor 313 of the fan 305 to rotate and/or enables the light-emitting module 309, so as to achieve a purpose of automatic enablement. In addition, the user can touch a decrease button D5 and an increase button D6 to adjust a delay time, such as specifying that the delay time is 10 minutes. Therefore, the control circuit 311 specifies a delay time of 10 minutes according to the command signal. When the motion sensor 3251 senses no motion of any object over the delay time, the control circuit 311 controls the motor 313 of the fan 305 to stop rotating and/or disables the light-emitting module 309. For example, 10 minutes after the user leaves the bathroom, the control circuit 311 controls the motor 313 of the fan 305 to stop rotating and/or disables the light-emitting module 309. The delay time mentioned above is stored in the storage module 333.

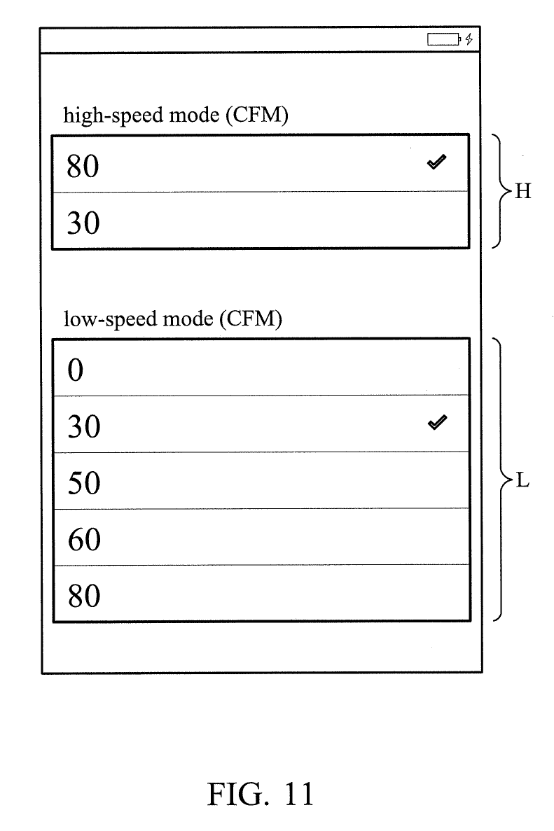

Please refer to FIG. 8 and FIG. 11. FIG. 11 is a diagram of a mode setting screen according to the embodiment of the present invention. As shown in FIG. 11, the user can set up a flow rate H in a high-speed mode and a flow rate L in a low-speed mode, such as setting up the flow rate H to 80 cubic feet per minute (CFM) and setting up the flow rate L to be 30 CFM. The control circuit 311 controls the motor 313 of the fan 305 to switch between the low-speed mode and the high-speed mode according to the user's setting or the environment information. For example, the control circuit 311 controls the motor 313 of the fan 305 to switch between the low-speed mode and the high-speed mode according to a sensing result of the motion sensor 3251. When the user does not enter the bathroom, the control circuit 311 controls the flow rate of the fan 305 is 30 CFM. When the user enters the bathroom, the control circuit 311 controls the flow rate of the fan 305 to switch from 30 CFM to 80 CFM. The user's setting is stored in the storage module 333.

The smart ventilation fan device 300 of the invention further includes an alerting function about the toxic gases, such as CO, CO2 or others toxic gases. When the gas sensor 3252 installed in the smart ventilation fan device 300 is a CO sensor, a gas concentration value sensed by the CO sensor is transmitted to the control circuit 311. When the gas concentration value is over a predetermined gas (such as CO) concentration setting value, the control circuit 311 transmits CO concentration information to the electronic device 200 through the second wireless module 307 to notify the user and controls the motor 313 of the fan 305 to start rotating, so as to achieve an effect of ventilation and to reduce the concentration of CO. The predetermined gas concentration setting value is stored in the storage module 333.

The smart ventilation fan device 300 of the invention further includes a function of showing the power consumption and the estimated electricity price. That is, the ventilation fan device information includes the power consumption and the estimated electricity price. The control circuit 311 can calculate the power consumption (watts, W) and the estimated electricity price by the formulas: estimated electricity price=fee per kilowatt-hour*usage amount of kilowatt-hour; and kilowatt-hour (KWh)=(power consumption*hour of usage)/1000. The power consumption and the estimated cost are transmitted to the first wireless module 203 of the electronic device 200 through the second wireless module 307, and the power consumption and the estimated electricity price is displayed on the electronic device 200 to notify the user. The smart ventilation fan system 100 can be integrated with other electric appliances in the future, so as to achieve a purpose of smart life. The formulas for calculating the power consumption and the estimated electricity price are stored in the storage module 333.

The smart ventilation fan device 300 of the invention further includes a function whereby the user is notified when the filter needs cleaning. The filter (not shown in figures) is disposed in the covering body 303. When the ventilation volume of the fan 305 does not achieve a predetermined ventilation volume setting value, the control circuit 311 transmits the ventilation fan device information which includes the ventilation volume to the electronic device 200 through the second wireless module 307 held by the user, so as to remind the user that the filter needs to be cleaned for energy savings. The predetermined ventilation volume setting value is stored in the storage module 333.

The smart ventilation fan device 300 of the invention further includes a function of event notification, which is applied to the bathroom especially. When the motion sensor 3251 installed in the smart ventilation fan device 300 senses that the user enters the bathroom, the motion sensor transmits a sensing value related to the motion of the user to the control circuit 311, and the control circuit 311 processes and determines according to the sensing value. When the control circuit 311 determines that the user does not leave the bathroom according to the sensing value transmitted by the motion sensor 3251 and the user does not move for a predetermined time (such as 30 minutes), the control circuit 311 transmits event information to the electronic device 200 held by another user through the second wireless module 307, so that the user who holds the electronic device 200 is able to deal with the event as soon as possible, such as going to the bathroom in a hurry or calling related persons or other persons (such as emergency medical technicians) to deal with the event, so as to provide assistance in the event that the user fainted or fell in the bathroom.

The smart ventilation fan device 300 of the invention further includes a speaker (not shown in figures). The speaker is fixedly disposed on the covering body 303 or casing 301. In another embodiment, the speaker can be detachably disposed on the covering body 303 or casing 301, so that the speaker can be separated from the covering body 303 or the casing 301 and be used separately. The speaker can communicate with the electronic device 200 having the first wireless module 203 through the second wireless module 307. In this embodiment, the first wireless module 203 and the second wireless module 307 can be Bluetooth modules. The user can operate the electronic device 200 to transmit music or radio broadcasts to the speaker using Bluetooth technology, and the music or radio is played by the speaker. For example, when the smart ventilation fan device 300 is installed in the bathroom, the user can use the electronic device 200 (such as a smartphone) to set up a music play list, and then the speaker plays the music, so that the user can listen to the music while taking a shower.

In contrast to the prior art, the smart ventilation fan system of the invention discloses a smart ventilation fan device combined with the user's smart electronic device (such as a mobile phone or a tablet) via wireless communication technology. When the smart electronic device detects the wireless module in the smart ventilation fan device, the smart electronic device can be paired to the wireless module. After the pairing procedure, the smart electronic device is combined with the smart electronic device, so that the user can use the smart electronic device to monitor current states (such as fan speed, ventilation volume, temperature and humidity of the environment) of the smart ventilation fan device. The user also can use the smart electronic device to adjust the settings of the functions of the smart ventilation fan device, and to adjust the brightness, color temperature and several modes of the light-emitting module in a wireless manner. The invention can reduce the cost of external accessories and of the construction. Conventionally, the ventilation volume and settings of a conventional high-level ventilation fan device need to be set up completely when installing the conventional high-level ventilation fan device. After installation, when the user wants to adjust some functions, the user has to remove the cover of the conventional high-level ventilation fan device to adjust the conventional high-level ventilation fan device. Thus, it is inconvenient and unsafe for the user to set up the functions of the conventional high-level ventilation fan device. However, with the present invention, it is easy and convenient for the user to use the smart electronic device to remotely control or adjust the settings of the smart ventilation fan device.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A smart ventilation fan device, comprising:
a fan, comprising a motor;
a sensor set, for sensing environment information outside of the smart ventilation fan device;
a wireless module, for receiving a command signal from an electronic device and transmitting the environment information and/or ventilation fan device information to the electronic device; and
a control circuit, for electrically connecting to the fan, the sensor set and the wireless module, the control circuit comprising a micro-controller, the micro-controller generating a control signal according to the command signal received by the wireless module, so as to control the motor of the fan to rotate, and the micro-controller processing the environment information sensed by the sensor set and/or the ventilation fan device information and transmitting the environment information and/or the ventilation fan device information to the electronic device through the wireless module.

2. The smart ventilation fan device as claimed in claim 1, further comprising:
a casing, for containing the fan and the control circuit; and
a covering body, for covering the casing;
wherein at least all or part of the wireless module is disposed outside of the casing.

3. The smart ventilation fan device as claimed in claim 2, wherein when the entire wireless module is disposed outside of the casing, the wireless module is disposed on the covering body.

4. The smart ventilation fan device as claimed in claim 2, wherein a base is formed on an inner surface of the casing, and the wireless module is disposed on the base.

5. The smart ventilation fan device as claimed in claim 2, further comprising:
a light-emitting module, disposed on the covering body and connected to the control circuit, so as to emit light beams;
wherein the control circuit generates the control signal according to the command signal received by the wireless module, so as to control the light-emitting module to emit the light beams.

6. The smart ventilation fan device as claimed in claim 5, wherein the light-emitting module comprises:
a plurality of first light-emitting diodes, for emitting yellow light beams of the light beams;
a plurality of second light-emitting diodes, for emitting white light beams of the light beams;
a first driving circuit; and
a second driving circuit;
wherein the first driving circuit and the second driving circuit respectively drive the first light-emitting diodes and the second light-emitting diodes to emit the yellow light beams and the white light beams;
wherein the first light-emitting diodes and the second light-emitting diodes are arranged alternatively or arranged in a staggered manner;
wherein a range of the color temperature of the light beams emitted from the light-emitting module is from 2300K to 5400K;
wherein a current percentage for driving the first light-emitting diodes by the first driving circuit and a current percentage for driving the second light-emitting diodes by the second driving circuit are derived from following formulas:
X+Y=A; and
BY=(100−B)*X;
wherein X is a maximum current percentage for driving the first light-emitting diodes, Y is a maximum current percentage for driving the second light-emitting diodes, A and B are integers, A is between 1 and 100, and B is between 0 and 100.

7. The smart ventilation fan device as claimed in claim 5, wherein the sensor set comprises a temperature sensor, a humidity sensor, a motion sensor, and a gas sensor, the temperature sensor and the humidity sensor are disposed inside the casing, the motion sensor is disposed on the covering body, and the gas sensor is disposed inside the casing or on the covering body; the environment information comprises motion information, gas concentration information, temperature information and humidity information of an indoor environment in which the smart ventilation fan device is located, and the environment information is obtained by the motion sensor, the gas sensor, the temperature sensor and the humidity sensor respectively.

8. The smart ventilation fan device as claimed in claim 7, wherein the control circuit specifies a target humidity setting value and a delay time according to the command signal, the control circuit controls the motor of the fan to rotate continuously and monitors whether a humidity value sensed by the humidity sensor achieves the target humidity setting value, when the humidity value achieves the target humidity setting value, the control circuit controls the motor of the fan to continue to rotate in the delay time, and when over the delay time, the control circuit controls the motor of the fan to stop rotating.

9. The smart ventilation fan device as claimed in claim 7, wherein when the motion sensor senses motion of an object, the control circuit controls the motor of the fan to start rotating and/or controls the light-emitting module to be enabled, and the control circuit specifies a delay time according to the command signal, when the motion sensor senses no motion of any object over the delay time, the control circuit controls the motor of the fan to stop rotating and/ or controls the light-emitting module to shut down.

10. The smart ventilation fan device as claimed in claim 7, wherein when the motion sensor senses that a user enters the indoor environment in which the motion sensor is located, the motion sensor transmits a sensing value related to motion of the user to the control circuit, the control circuit processes and determines according to the sensing value, when the control circuit determines that the user does not leave the indoor environment and does not move for a predetermined time, the control circuit transmits event information to the electronic device through the wireless module.

11. The smart ventilation fan device as claimed in claim 7, wherein a gas concentration value sensed by the gas sensor is over a predetermined gas concentration setting value, the control circuit controls the motor of the fan to start rotating.

12. The smart ventilation fan device as claimed in claim 2, further comprising a filter disposed in the covering body, wherein the ventilation fan device information comprises ventilation volume of the fan, and when the ventilation volume does not reach a predetermined ventilation volume setting value, the control circuit transmits the ventilation fan device information which comprises the ventilation volume of the fan to the electronic device through the wireless module.

13. The smart ventilation fan device as claimed in claim 1, wherein the ventilation fan device information comprises power consumption and an estimated electricity price for the smart ventilation fan device, and the control circuit calculates the power consumption and the estimated electricity price of the smart ventilation fan device and transmits the ventilation fan device information which comprises the power consumption and the estimated electricity price of the smart ventilation fan device to the electronic device through the wireless module.

14. The smart ventilation fan device as claimed in claim 2, further comprising a speaker fixedly disposed on or detachably disposed on the covering body or the casing, and the speaker communicating with the electronic device through the wireless module.

15. The smart ventilation fan device as claimed in claim 1, wherein the control circuit controls the motor of the fan to operate in a low-speed mode or in a high-speed mode, and the control circuit controls the motor of the fan to switch between the low-speed mode and the high-speed mode according to the environment information.

16. The smart ventilation fan device as claimed in claim 1, further comprising a storage module for storing a plurality of settings for the control circuit.

17. The smart ventilation fan device as claimed in claim 5, further comprising:
an AC-DC converter, for converting an external alternating current power into a direct current power; and
a voltage regulator, for converting the direct current power into a control voltage and providing the control voltage to the sensor set, the light-emitting module, the control circuit and the wireless module.

18. A smart ventilation fan system, comprising:
an electronic device, comprising:
a human interface, for receiving an input signal;
a processor, for generating a command signal according to the input signal;
a first wireless module, for outputting the command signal; and
a storage medium, comprising an application program which is processed by the processor; and
a smart ventilation fan device, comprising:
a fan, comprising a motor;
a sensor set, for sensing environment information outside of the smart ventilation fan device;
a second wireless module, communicating with the first wireless module for receiving the command signal from the electronic device and transmitting the environment information and/or ventilation fan device information to the electronic device; and
a control circuit, for electrically connecting to the fan, the sensor set and the second wireless module, the control circuit comprising a micro-controller, the micro-controller generating a control signal according to the command signal received by the second wireless module, so as to control the motor of the fan to rotate, and the micro-controller processing the environment information sensed by the sensor set and/or the ventilation fan device information and transmitting the environment information and/or the ventilation fan device information to the electronic device through the second wireless module.

19. The smart ventilation fan system as claimed in claim 18, wherein the smart ventilation fan device further comprises a light-emitting module electrically connected to the control circuit for emitting light beams, and the control circuit generates the control signal according to the command signal received by the second wireless module, so as to control the light-emitting module to emit the light beams.

20. The smart ventilation fan system as claimed in claim 19, wherein the processor runs the application program to show the environment information and/or the ventilation fan device information on the human interface of the electronic device, and the human interface comprises several user options for determining whether the fan, the sensor set and the light-emitting module are enabled and for specifying a plurality of control parameters of the sensor set, wherein the environment information comprises motion information, gas concentration information, temperature information and humidity information of an indoor environment in which the smart ventilation fan device is located, and the ventilation fan device information comprises ventilation volume, power consumption, and an estimated electricity price.
